(19) United States
(12) Patent Application Publication
(10) Pub. No.: US 2009/0146332 A1
(43) Pub. Date: Jun. 11, 2009

(54) METHOD AND DEVICE FOR POSITIONING A COMPONENT

(76) Inventors: Michael Linke, Hamburg (DE); Michael Litzenberg, Geesthacht (DE); Rolf Baumgarte, Ahrensburg (DE)

Correspondence Address: FRIEDRICH KUEFFNER, 317 MADISON AVENUE, SUITE 910, NEW YORK, NY, 10017, US

(21) Appl. No.: 11/989,505

(22) PCT Filed: Jul. 17, 2006
(86) PCT No.: PCT/DE2006/001265

§ 371 Date: Mar. 11, 2008

(30) Foreign Application Priority Data
Jul. 26, 2005 (DE) 10 2005 034 846.7

(51) Int. Cl. B29C 49/00; B28B 17/00

(52) U.S. Cl. 264/40.1; 425/150

(57) ABSTRACT

The invention relates to a method and device for positioning a component. A hydraulic drive displaces the component along a guide. A position marking for the component is read by at least one sensor. An output signal is transmitted to a controller and the controller regulates a position of the component by means of a variation in the supply of fluid depending on the output signal from the sensor.

The invention concerns a method for positioning a component, in which a fluid drive moves the component along a guide.

The invention also concerns a device for positioning a component, which has a fluid drive and a guide for moving the component.

These kinds of methods and devices are used, for example, in the blow molding of containers, in which a preform is stretched by a stretch rod during thermal conditioning inside a blow mold and blow molded into the container by the action of blowing pressure. The stretch rods are often positioned by pneumatic cylinders.

In container molding by the action of blowing pressure, preforms made of a thermoplastic material, for example, preforms made of PET (polyethylene terephthalate), are fed to different treatment stations within a blow-molding machine. A blow-molding machine of this type typically has a heating system and a blowing system, in which the preform, which has first been brought to a desired temperature, is expanded into a container by biaxial orientation. The expansion is effected by means of compressed air, which is fed into the preform to be expanded. DE-OS 43 40 291 explains the process-engineering sequence in this type of preform expansion. The aforementioned introduction of the pressurized gas comprises both the introduction of compressed gas into the developing container bubble and the introduction of compressed gas into the preform at the beginning of the blowing operation.

The basic design of a blowing station for container molding is described in DE-OS 42 12 583. Possible means of bringing the preform to the desired temperature are explained in DE-OS 23 52 926.

Various handling devices can be used to convey the preforms and the blow-molded containers within the blow-molding device. The use of transport mandrels, onto which the preforms are slipped, has proven especially effective. However, the preforms can also be handled with other supporting devices. Other available designs involve the use of gripping tongs for handling the preforms and the use of expanding mandrels, which can be inserted in the mouth region of the preform to support the preform.

The handling of containers with the use of transfer wheels is described, for example, in DE-OS 199 06 438 with the transfer wheel arranged between a blowing wheel and a delivery line.

The above-explained handling of the preform occurs, for one thing, in so-called two-step processes, in which the preforms are first produced by injection molding and temporarily stored and then later conditioned with respect to their temperature and blown into containers. For another, the preforms can be handled in so-called one-step processes, in which the preforms are first produced by injection molding and allowed to solidify sufficiently and are then immediately suitably conditioned with respect to their temperature and then blow molded.

With respect to the blowing stations that are used, various embodiments are known. In the case of blowing stations that are arranged on rotating transport wheels, book-like opening of the mold supports is often encountered. However, it is also possible to use mold supports that can be moved relative to each other or that are guided in a different way. In stationary blowing stations, which are suitable especially for accommodating several cavities for container molding, plates arranged parallel to one another are typically used as mold supports.

DE-OS 101 45 579 gives a detailed description of a stretching system of a blowing station with an associated stretch rod. The stretch rod is designed here as a solid rod, and the blowing air is fed to the blow mold through a connecting piston that has a larger inside diameter than the outside diameter of the stretch rod. This produces an annular gap between the stretch rod and an inner surface of the connecting piston, through which the pressurized gas can flow.

The use of a hollow stretch rod is described, for example, in DE-OS 28 14 952. A connection for the pressurized gas is created in this case by an end of the tubularly shaped stretch rod that faces away from a stretch rod tip. Supplying pressurized gas through the end of a hollow stretch rod is also described in DE-OS 34 08 740 C2.

DE-OS 103 25 229.0 already describes the positioning of a stretch rod with the use of an electric linear drive, which is designed on the basis of an operating principle similar to that of a high-speed train system. Linear motors of this type allow highly precise reproducibility in the performance of stretching movements, but they have a comparatively high structural weight and a high price.

In general, each of the previously known devices for positioning components has a series of individual advantages, but so far it has not been possible to satisfy all of the requirements, namely, a low structural weight, a low price of the device, and precise performance of the positioning movements.

The objective of the present invention is to improve a method of the type described at the beginning in a way that is conducive to exact performance of positioning movements with a low resulting equipment weight.

In accordance with the invention, this objective is achieved by virtue of the fact that at least one positioning marker of the component is detected by at least one sensor, that an output signal of the sensor is supplied to a control unit, and that the control unit automatically controls a position of the component by varying the supply of the fluid as a function of the output signal of the sensor.

A further objective of the invention is to design a device of the type described at the beginning in such a way that exact performance of positioning movements is made possible at a low price of the device and at a low device weight.

In accordance with the invention, this objective is achieved by virtue of the fact that the component has at least one positioning marker, that at least one sensor for detecting the positioning marker is mounted in the vicinity of the guide, that the sensor is connected with a control unit for the fluid drive, and that the control unit is connected with a control element for varying the supply of fluid as a function of the output signal of the sensor and for carrying out automatic position control.

The combination of the fluid drive with position detection and position-dependent automatic control of the supply of fluid makes it possible, with the use of a simple and inexpensive fluid drive, for example, a pneumatically operated cylinder, to achieve positional accuracy that would otherwise be possible only with the use of servomotors or linear motors. Compared to the use of servomotors or linear motors, the use of an automatically controlled fluid drive offers the advantage of extreme compactness, a high degree of robustness, and the development of a large amount of power per required element of volume. The automatic control of the fluid drive could thus make it possible to combine the advantages of the previously known drive systems with one another.

An especially inexpensive embodiment is provided by using a pneumatic drive as the fluid drive.

Especially high actuating forces can be produced by using a hydraulic drive as the fluid drive.

To realize a simple design, it is helpful if the fluid drive carries out a linear movement.

The accuracy of position detection can be improved if optical means are used to detect the position.

Position detection without contact can be realized if optical means are used to detect the position.

In another design variant, magnetic means are used to detect the position.

Fast and precise controllability of the supply of fluid is made possible if the control unit drives an electrically controllable valve.

An embodiment that produces high actuating forces and at the same time has a compact design is realized if a piston that moves within a cylinder is used as the fluid drive.

To achieve controllability that is both fast and accurate, it is useful if the piston can be acted upon on two sides by the actuating pressure.

A very high level of automatic control quality with a compact design can be realized if a linear motor is used as the sensor.

In a preferred embodiment, the device is used in a blow-molding machine.

In particular, it is contemplated that the device be used in a stretching system of a blow-molding machine.

Further optimization of the method in connection with the performance of blow-molding operations is achieved if blowing valve control is carried out as a function of position detection provided by the linear drive.

Specific embodiments of the invention are schematically illustrated in the drawings.

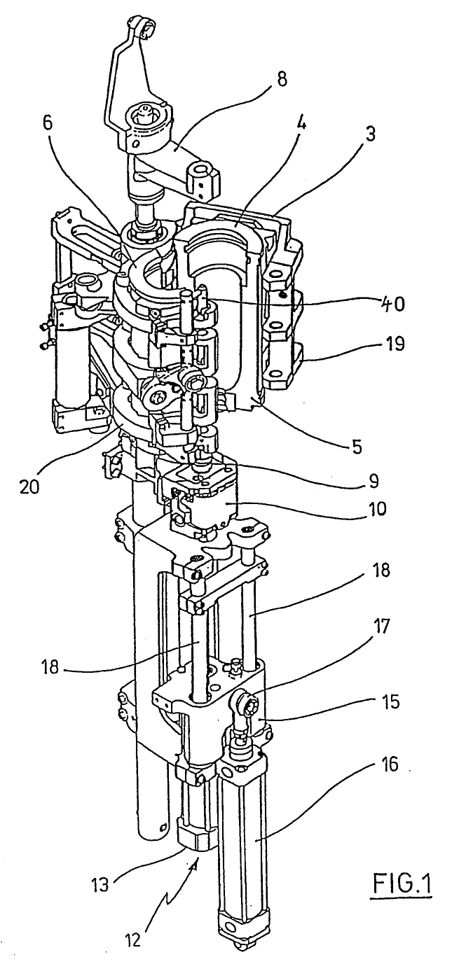

FIG. 1 shows a perspective view of a blowing station for producing containers from preforms.

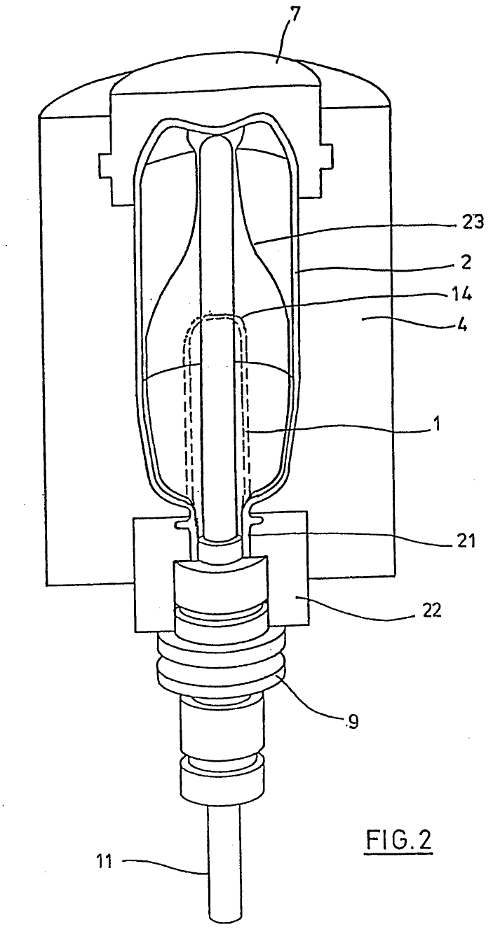

FIG. 2 shows a longitudinal section through a blow mold, in which a preform is stretched and expanded.

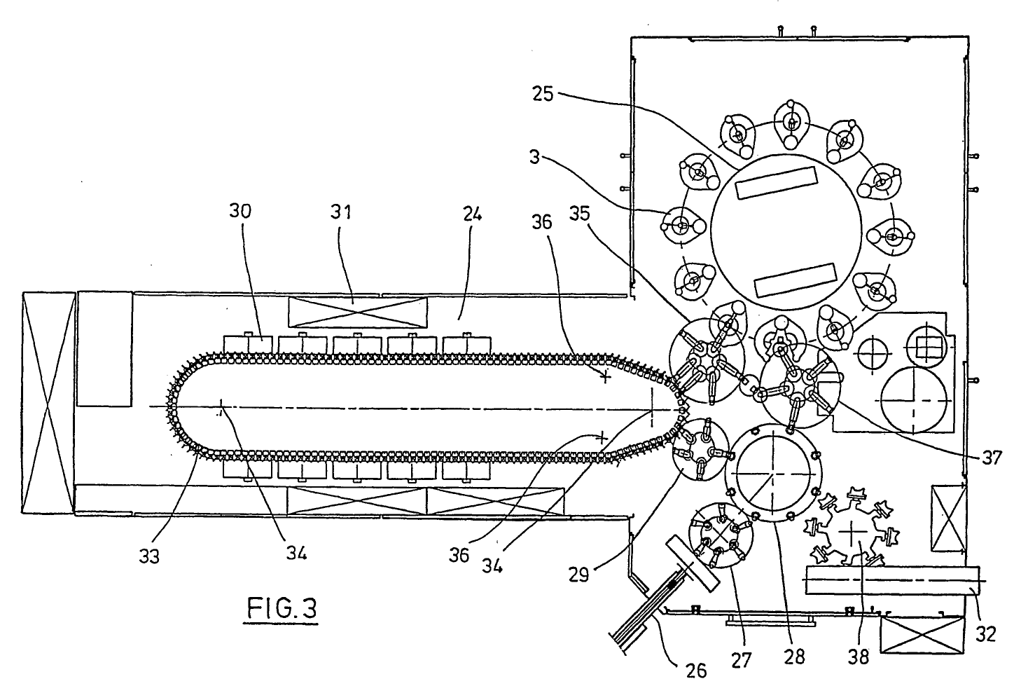

FIG. 3 shows a drawing that illustrates a basic design of a device for blow molding containers.

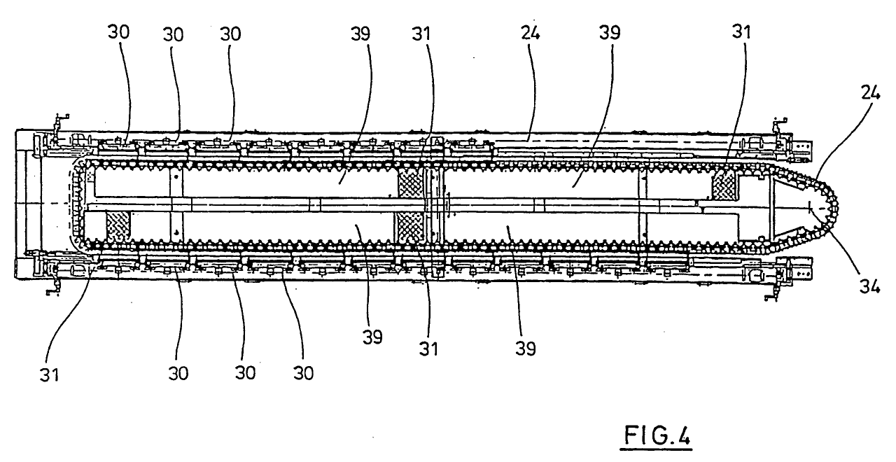

FIG. 4 shows a modified heating line with increased heating capacity.

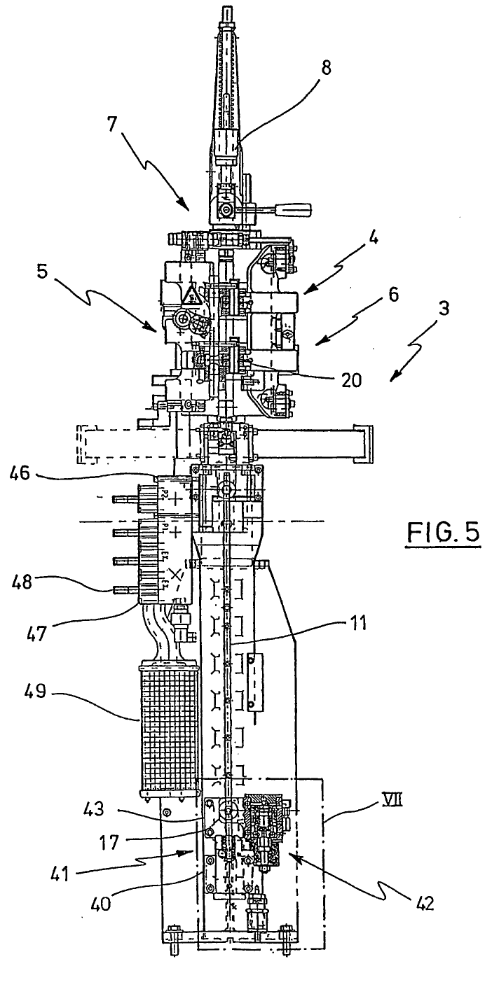

FIG. 5 shows a side view of a blowing station, in which a stretch rod is positioned by a stretch rod carrier.

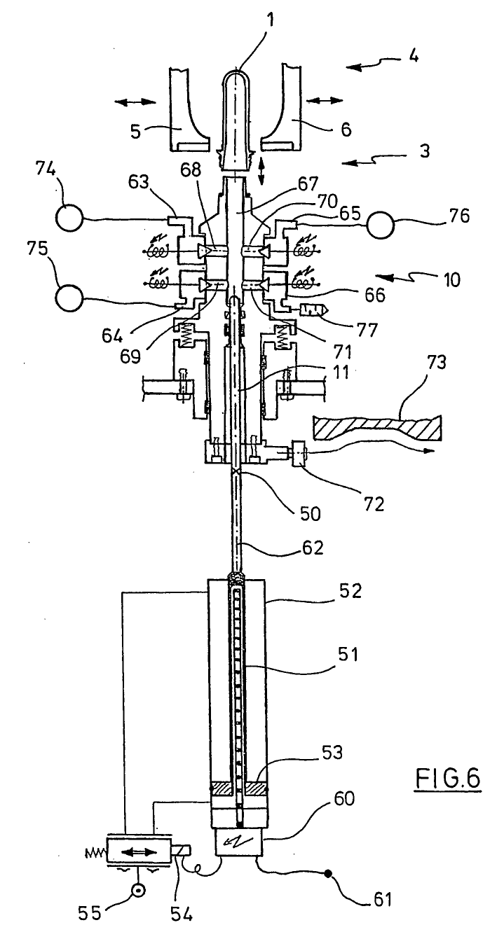

FIG. 6 shows a schematic side view of a blowing station, in which the stretch rod is positioned by an actuating rod, on which an automatically controlled pneumatic piston acts.

FIGS. 1 and 2 show the basic design of a device for shaping preforms 1 into containers 2.

The device for molding the container 2 consists essentially of a blowing station 3, which is provided with a blow mold 4, into which a preform 1 can be inserted. The preform 1 can be an injection-molded part made of polyethylene terephthalate. To allow the preform 1 to be inserted into the blow mold 4 and to allow the finished container 2 to be removed, the blow mold 4 consists of mold halves 5, 6 and a base part 7, which can be positioned by a lifting device 8. The preform 1 can be held in place in the area of the blowing station 3 by a transport mandrel 9, which, together with the preform 1, passes through a large number of treatment stations within the device. However, it is also possible to insert the preform 1 directly into the blow mold 4, for example, with tongs or other handling devices.

To allow compressed air to be fed in, a connecting piston 10 is arranged below the transport mandrel 9. It supplies compressed air to the preform 1 and at the same time produces a seal relative to the transport mandrel 9. However, in a modified design, it is also basically possible to use stationary compressed air feed lines.

In this embodiment, the preform 1 is stretched by means of a stretch rod 11, which is positioned by a cylinder 12. In accordance with another embodiment, the stretch rod 11 is mechanically positioned by means of cam segments, which are acted upon by pickup rollers. The use of cam segments is advantageous especially when a large number of blowing stations 3 is arranged on a rotating blowing wheel.

In the embodiment illustrated in FIG. 1, the stretching system is designed in such a way that a tandem arrangement of two cylinders 12 is provided. Before the start of the actual stretching operation, the stretch rod 11 is first moved into the area of a base 14 of the preform 1 by a primary cylinder 13. During the stretching operation itself, the primary cylinder 13 with the stretch rod extended, together with a carriage 15 that carries the primary cylinder 13, is positioned by a secondary cylinder 16 or by means of cam control. In particular, it is proposed that the secondary cylinder 16 be used in such a way under cam control that a current stretching position is predetermined by a guide roller 17, which slides along a cam track while the stretching operation is being carried out. The guide roller 17 is pressed against the guide track by the secondary cylinder 16. The carriage 15 slides along two guide elements 18.

After the mold halves 5, 6, which are arranged in the area of supports 19, 20, are closed, the supports 19, 20 are locked relative to each other by means of a locking mechanism 40.

To adapt to different shapes of a mouth section 21 of the preform 1, provision is made for the use of separate threaded inserts 22 in the area of the blow mold 4, as shown in FIG. 2.

In addition to the blow-molded container 2, FIG. 2 shows the preform 1, which is drawn with broken lines, and also shows schematically a container bubble 23 in the process of development.

FIG. 3 shows the basic design of a blow-molding machine, which has a heating line 24 and a rotating blowing wheel 25. Starting from a preform feeding device 26, the preforms 1 are conveyed to the area of the heating line 24 by transfer wheels 27, 28, 29. Radiant heaters 30 and fans 31 are arranged along the heating line 24 to bring the preforms 1 to the desired temperature. After sufficient heat treatment of the preforms 1, they are transferred to the blowing wheel 25, where the blowing stations 3 are located. The finished blow-molded containers 2 are fed to a delivery line 32 by additional transfer wheels.

To make it possible for a preform 1 to be blow molded into a container 2 in such a way that the container 2 has material properties that ensure a long shelf life of the foods, especially beverages, with which the container 2 is to be filled, specific process steps must be followed during the heating and orientation of the preforms 1. In addition, advantageous effects can be realized by following specific dimensioning specifications.

Various plastics can be used as the thermoplastic material. For example, PET, PEN, or PP can be used.

The preform 1 is expanded during the orientation process by feeding compressed air into it. The operation of supplying compressed air is divided into a preblowing phase, in which gas, for example, compressed air, is supplied at a low pressure level, and a subsequent main blowing phase, in which gas is supplied at a higher pressure level. During the preblowing phase, compressed air with a pressure in the range of 10 bars to 25 bars is typically used, and during the main blowing phase, compressed air with a pressure in the range of 25 bars to 40 bars is supplied.

FIG. 3 also shows that in the illustrated embodiment, the heating line 24 consists of a large number of revolving transport elements 33, which are strung together like a chain and are moved along by guide wheels 34. In particular, it is proposed that an essentially rectangular basic contour be set up by the chain-like arrangement. In the illustrated embodiment, a single, relatively large-sized guide wheel 34 is used in the area of the extension of the heating line 24 facing the transfer wheel 29 and a feed wheel 35, and two relatively small-sized guide wheels 36 are used in the area of adjacent deflections. In principle, however, any other types of guides are also conceivable.

To allow the closest possible arrangement of the transfer wheel 29 and the feed wheel 35 relative to each other, the illustrated arrangement is found to be especially effective, since three guide wheels 34, 36 are positioned in the area of the corresponding extension of the heating line 24, namely, the smaller guide wheels 36 in the area of the transition to the linear stretches of the heating line 24 and the larger guide wheel 34 in the immediate area of transfer to the transfer wheel 29 and to the feed wheel 35. As an alternative to the use of chain-like transport elements 33, it is also possible, for example, to use a rotating heating wheel.

After the blow molding of the containers 2 has been completed, the containers 2 are carried out of the area of the blowing stations 3 by an extraction wheel 37 and conveyed to the delivery line 32 by the transfer wheel 28 and a delivery wheel 38.

In the modified heating line 24 illustrated in FIG. 4, a larger number of preforms 1 can be heated per unit time due to the larger number of radiant heaters 30. The fans 31 in this case feed cooling air into the area of cooling air ducts 39, which lie opposite the associated radiant heaters 30 and deliver the cooling air through discharge ports. A direction of flow of the cooling air essentially transverse to the direction of conveyance of the preforms 1 is realized by the arrangement of the discharge directions. In the area of surfaces opposite the radiant heaters 30, the cooling air ducts 39 can provide reflectors for the thermal radiation. It is also possible to realize cooling of the radiant heaters 30 by the delivered cooling air.

FIG. 5 shows a view of the blowing station 3 that is modified relative to FIG. 1, with a direction of viewing from the front. In particular, this view shows that the stretch rod 11 is supported by a stretch rod carrier 41, which consists of a carrier base 44 and a roller carrier 43, which is connected with the carrier base 40 by a coupling element 42. The roller carrier 43 supports the guide roller 17, which serves to position the stretching system. The guide roller 17 moves along a cam track (not shown). Complete mechanical control of the stretching process is realized here.

The coupling element 42 illustrated in FIG. 5 can also be used in the embodiment of FIG. 1 to allow complete mechanical decoupling of the cylinders 12 from each other or from a supporting member for the guide roller 17.

FIG. 5 illustrates an engaged state of the coupling element 42, in which the carrier base 44 and the roller carrier 43 are connected with each other by the coupling element 42. This results in a rigid mechanical coupling, which causes positioning of the guide roller 17 to be directly and immediately converted to positioning of the stretch rod 11. As a result, exactly predetermined positioning of the stretch rod 11 is present in every state of movement of the blowing wheel 25, and with a large number of blowing stations 3 arranged on the blowing wheel 25, the positioning of the stretch rod 11 is exactly reproduced in each blowing station 3. This exact mechanical presetting of the positioning of the stretch rod 11 contributes to high product quality and a high degree of uniformity of the containers 2 that are produced.

FIG. 5 also shows the arrangement of a pneumatic block 46 for supplying blowing pressure to the blowing station 3. The pneumatic block 46 is equipped with high-pressure valves 47, which can be connected by connections 48 to one or more pressure supply sources. After the containers 2 have been blow molded, blowing air to be discharged to the environment is first fed to a muffler 49 via the pneumatic block 46.

FIG. 6 shows an embodiment in which the stretch rod 11 is coupled with a positioning rod 51 via a coupling point 50. In principle, the stretch rod 11 and the positioning rod 51 can also be constructed as a single part, but a two-part design allows product-dependent exchange of the stretch rod 11 without changes in the stretch rod drive. In the illustrated embodiment, the positioning rod is guided coaxially in a cylinder 52 and can be displaced by a piston 53. The cylinder 52 is connected to a supply 55 by a valve 54. In the illustrated embodiment, the supply 55 is a pneumatic supply, and the valve 54 can be designed as a solenoid valve. To carry out both lifting and lowering movements of the stretch rod 11, both an area above and an area below the piston 53 can be acted upon by pressure via the valve 54.

In the embodiment illustrated in FIG. 6, the preforms 1 are blow molded into containers 2 with the mouths of the preforms oriented vertically downward. However, the arrangement can also be turned 180° relative to the view in FIG. 6, so that the preforms 1 are molded into containers 2 with their mouths oriented vertically upward.

According to the embodiment in FIG. 6, the positioning rod 51 and the piston 53 are rigidly connected with each other. This can be accomplished, for example, by screwing an outer thread of the positioning rod 51 into the inner thread of a corresponding hole in the piston 53. The positioning rod 51 has an interior space 56 that contains a marker bar 57, which is provided with a plurality of markers 58 that are arranged in succession in the longitudinal direction 62. The markers 58 are detected by a sensor (not shown) to determine the given position of the positioning rod 51, and this position is then transmitted to the control unit 60. The control unit 60 controls the pneumatic supply of the cylinder 52 by means of the valve 54 and in this way realizes automatic position control for the positioning rod 51.

The valve 54 can be designed, for example, as a 5/3-way valve. Alternatively to an arrangement of the positioning markers on a marker bar 57, it is also possible to provide corresponding markers on the positioning rod 51 and to position the position sensor, for example, on the marker bar 57, in a different place within the interior space 56 of the rod, or outside the positioning rod 51 or the piston 53.

In accordance with another embodiment, a linear motor is used as a position measuring system. In accordance with a special embodiment, the linear motor does not contribute to the driving of the positioning rod 51 but rather acts only as the position measuring system. This allows the use of a linear motor with small dimensions, low structural weight, low structural volume and low cost. The linear motor is thus used in this embodiment only as a highly precise position measuring system.

The positioning rod 51 has a position measuring device for detecting a given position of the actuating rod 58. The position measuring system integrated in the positioning rod 51 makes it possible to control the times for switching on the blowing valves for the blowing station 3. At least one of these valves (63, 64, 65, 66) is a preblowing pressure valve, a main blowing pressure valve, a blowing air return valve, and a vent valve for the blow-molded container 3. This allows exact coordination between the time sequences for stretching and blowing.

FIG. 6 additionally shows a design of the connecting piston 10 in which blowing air valves 63, 64, a blowing air return valve 65, and a vent valve 66 are mounted directly on the connecting piston 10 and can be positioned together with it. An interior space 67 of the connecting piston 10 is connected with the valves 63, 64, 65, 66 by respective connecting channels 68, 69, 70, 71. The connecting piston 10 can be positioned under cam control in such a way that a cam roller 72 connected with the connecting piston 10 moves along a control cam 73. Blowing air valve 63 is connected to a low-pressure compressed air source 74, and blowing air valve 64 is connected to a high-pressure compressed air source 75. The blowing air return valve 65 is connected to a return system 76, and the vent valve 66 is connected to a muffler 77.

The combination of the pneumatic drive and the automatic electric control makes it possible, with a low structural weight and high available stretching forces, to provide a programmable stretching movement for almost any desired size of containers 2. In particular, it is possible by means of operator control to adapt to different products to be produced without changing heavy mechanical stretching cams.

In accordance with another embodiment, it is also contemplated that each individual blowing station 3 be provided with its own control system, which controls the respective blowing operation in a locally distributed way. This results in systems that are very simple and unsusceptible to problems, so that even in the event of a local failure of individual components, the other blowing stations remain functional.

1. A method for positioning a component, in which a fluid drive moves the component along a guide, wherein at least one positioning marker of the component is detected by at least one sensor; an output signal of the sensor is supplied to a control unit; and the control unit automatically controls a position of the component by varying the supply of the fluid as a function of the output signal of the sensor.

2. A method in accordance with claim 1, wherein a pneumatic drive is used as the fluid drive.

3. A method in accordance with claim 1, wherein a hydraulic drive is used as the fluid drive.

4. A method in accordance with claim 1, wherein the fluid drive carries out a linear movement.

5. A method in accordance with claim 1, wherein the sensor detects the position of a plurality of markers.

6. A method in accordance with claim 1, wherein optical means are used to detect the position.

7. A method in accordance with claim 1, wherein magnetic means are used to detect the position.

8. A method in accordance with claim 1, wherein the control unit drives an electrically controllable valve.

9. A method in accordance with claim 1, wherein a piston that moves within a cylinder is used as the fluid drive.

10. A method in accordance with claim 1, wherein the piston can be acted upon on two sides by the actuating pressure.

11. A method in accordance with claim 1, wherein a linear motor is used as the sensor.

12. A method in accordance with claim 1, wherein the device is used in a blow-molding machine.

13. A method in accordance with claim 1, wherein the device be used in a stretching system of a blow-molding machine.

14. A method in accordance with claim 1, wherein blowing valve control is carried out as a function of a position determination that has been made.

15. A device for positioning a component, which has a fluid drive and a guide for moving the component, wherein the component has at least one positioning marker; at least one sensor for detecting the positioning marker is mounted in the vicinity of the guide; the sensor is connected with a control unit for the fluid drive; and the control unit is connected with a control element for varying the supply of fluid as a function of the output signal of the sensor and for carrying out automatic position control.

16. A device in accordance with claim 15, wherein the fluid drive is pneumatic.

17. A device in accordance with claim 15, wherein the fluid drive is hydraulic.

18. A device in accordance with claim 15, wherein the fluid drive is designed to carry out a linear movement.

19. A device in accordance with claim 15, wherein at least two markers are located along a path of movement of the fluid drive.

20. A device in accordance with claim 15, wherein the sensor is designed for optical position detection.

21. A device in accordance with claim 15, wherein the sensor is designed for magnetic position detection.

22. A device in accordance with claim 15, wherein the control element is designed as an electrically controllable valve.

23. A device in accordance with claim 15, wherein the fluid drive has at least one piston (53) that moves within a cylinder (52).

24. A device in accordance with claim 23, wherein the piston (53) is arranged in such a way that it can be acted upon on two sides by the pressurized fluid.

25. A device in accordance with claim 15, wherein the sensor is designed as part of a linear motor.

26. A device in accordance with claim 15, wherein the fluid drive is used in a blow-molding machine.

27. A device in accordance with claim 15, wherein the fluid drive is used in the stretching system of a blow-molding machine.

28. A device in accordance with claim 15, wherein valve control of a blowing station (3) of the blow-molding machine is coupled with the position detection of the fluid drive.
